(19) United States
(12) Patent Application Publication
(10) Pub. No.: US 2005/0230891 A1
(43) Pub. Date: Oct. 20, 2005

(54) Jounce bumper

(76) Inventor: Gary J. Griffin, Fraser, MI (US)

Correspondence Address: Peter N. Lalos, Esq.;Kenneth J. Whittington, Esq., Stevens, Davis, Miller & Mosher, LLP, 1615 L Street, NW, Suite 850, Washington, DC, 20036-5622, US

(21) Appl. No.: 10/823,746

(22) Filed: Apr. 14, 2004

(51) Int. Cl. B60G 11/22; F16F 1/36

(52) U.S. Cl. 267/292

(57) ABSTRACT

An energy absorption device for providing a softer stop arrangement between a pair of components. A compressible bumper is placed into a flexible cup. A ring is place around the flexible cup. Upon application of force between the components, the compressible bumper collapses into the flexible cup and the cup begins to expand radially. The ring prevents the cup from expanding to the point of flattening and provides the device with a definite rigid stop. The device is usable between any two components to prevent collisions between the components up to a certain force between them and is also usable between a strut assembly and a vehicle suspension frame.

This invention relates to a jounce bumper for motor vehicle suspensions systems either in the strut assemblies or other locations.

### BACKGROUND OF INVENTION

Microcellular urethane bumpers are used in vehicle suspensions to absorb energy during jounce and to act as a supplemental spring. The bumper 100 has a general appearance as shown in FIG. 1. These could be mounted on a strut assembly, as shown in the U.S. Pat. No. 5,487,535, where the bumper surrounds the piston rod of the strut. A hole 110 through bumper 100 allows for passage of the piston rod. This bumper prevents the cylinder of the strut assembly from impacting heavily the mounting assembly. The bumpers could also be mounted in other locations, as shown in U.S. Pat. No. 5,725,203, where the bumper is free standing to prevent a control arm of the suspension from impacting with the vehicle frame.

Bumpers can be mounted in a free state or within a rigid cup, as shown in U.S. Pat. No. 6,158,726 which discloses a bumper with the use of a rigid cup attached. An example of a rigid cup is shown in FIG. 2, and is identified as rigid cup 200. The operation of a rigid cup assembly is shown in FIGS. 3A-3C, illustrating a bumper assembly 350. The rigid cup 310, shown here with a lip 311, acts to attach the bumper 100 to the vehicle or the strut (not shown) and limits the bumper distortion, thereby increasing its rate. A force, provided by a rod or other device 220, acts upon the bumper assembly 350 in the direction F, as shown in FIG. 3B. The force necessary to compress the bumper assembly 350 increases as the bumper is compressed and the bumper absorbs energy as it is compressing. As the bumper 100 is compressed, the resistance to compression increases to the point where the bumper acts as a solid, and transfers the remaining energy from the impact to the vehicle. Such state is illustrated in FIG. 3C. The use of a rigid cup or another constraint limits the bulging of the bumper, thereby reducing the amount of travel needed to reach the point where the bumper becomes a solid.

In general, when more energy must be removed, a larger bumper is used. Recent styling trends are dictating the use of low profile tires, which in effect removes an important energy management element. To counteract the loss of the cushioning given by higher profile tires, the jounce bumpers must absorb much greater amounts of energy. In most cases, there is not enough space to package a bumper large enough to absorb the amount of energy experience during an impact.

To absorb this energy effectively, other designs have sought to modify the bumper cup whereby the jounce bumper is placed into an elastic cup. Such is disclosed in U.S. Pat. No. 6,485,008, which is incorporated by reference herein in its entirety. The functionality of this assembly is shown in FIGS. 4A-4C. In such jounce bumper assembly 450, the bumper 400, made of a microcellular urethane, compresses into the elastic bumper cup 410, made of a thermoplastic urethane. The bumper assembly 450 is located between two objects 460 and 461. When a force in the direction F, provided by object 460 in the direction of object 461, begins to act on the bumper assembly, the bumper 400 begins to compress into the bumper cup 410. As the force increases, the amount that bumper 400 is compressed into bumper cup 410 increases. In response to this increase, the bumper cup begins to expand outward in the direction W at its rim portion 412. This combination of compression and expansion allows the bumper cup assembly to absorb more energy and the bumper assembly to be compressed into a smaller space D1 than the rigid bumper cup designs. However, a problem with such bumper cup assemblies is that they do not provide a positive stop to the system. Upon sufficient force upon the bumper assembly, it will flatten.

### SUMMARY OF INVENTION

One object of the invention is to provide a bumper assembly that overcomes the limiting effect a rigid cup has on a bumper assembly and overcomes the non-limiting effect of an elastic cup. Another object of the invention is to provide a compact bumper assembly capable of absorbing a larger amount of energy than a similar sized bumper assembly, provide more travel of the strut assembly, while at the same time providing a positive stop to the assembly.

These and other problems are overcome with a bumper assembly comprising a microcellular urethane (MCU) jounce bumper placed into a thermoplastic urethane (TPU) cup. The MCU bumper is partially placed within the TPU cup attached to a surface of either a strut assembly or free standing in another assembly. A ring is then placed around the outer surface of the TPU cup. The ring may either surround the entire side surface of the TPU cup or the ring may only partially surround the cup.

As a force acts upon the MCU bumper, it begins to press into the TPU cup. Upon an increasing force being applied, the TPU cup begins to expand outwardly at its opening at the same time the MCU bumper compresses within the TPU cup. Thus, the combination of the bumper and the cup act in unison to receive the force, and allow more travel of the strut assembly as the cup expands. However, the ring limits this expansion of the TPU cup. The small ring will restrict the expansion of the TPU cup a small amount and a taller ring will restrict to a greater degree. Such restriction prevents the bumper assembly from being flattened and provides a positive stop to the assembly. As a result, the combination bumper assembly is capable of absorbing an increased amount of energy in a compact area while still allowing more travel of the strut assembly and providing a positive stop.

### BRIEF DESCRIPTION OF THE DRAWINGS

A preferred embodiment of the invention will now be described with reference to the accompanying drawings, in which:

FIG. 1 is a perspective view of a bumper;

FIG. 2 is a perspective view of a metal cup;

FIGS. 3A, 3B and 3C illustrate the operation of a prior art bumper using a rigid cup; and

FIGS. 4A, 4B and 4C illustrate the operation of another prior art bumper using an elastic cup;

FIG. 5A is a perspective view of the components of the jounce bumper according to the invention;

FIG. 5B is an assembled view of the jounce bumper components shown in FIG. 5A;

FIGS. 6A, 6B and 6C illustrate the operation of the jounce bumper according to the invention using a ring with a smaller height;

FIGS. 7A, 7B and 7C illustrate the operation of the jounce bumper according to the invention using a ring with an increased height;

FIG. 8 illustrates the load versus the deflection of jounce bumpers according to the invention in comparison to jounce bumpers of the prior art; and

FIG. 9 illustrates the energy versus the deflection of jounce bumpers according to the invention in comparison to the jounce bumpers of the prior art.

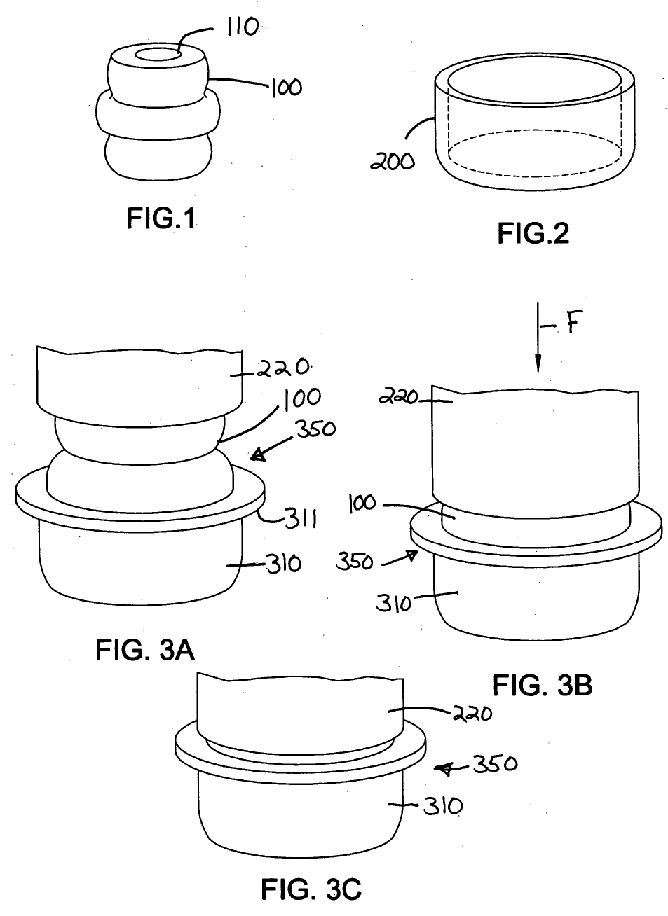

### DETAILED DESCRIPTION OF THE PREFERRED EMBODIMENT

When the vehicle travels over a bump, a strut assembly collapses to absorb the shock. Upon incurring a force greater than the force the strut can handle, the strut will bottom out, or completely collapse. Bumper assemblies provide a cushion between the cylinder of the strut and the surface to which the strut is attached. In some strut assemblies, a rigid cup is used to mount the bumper, as shown in FIGS. 3A, 3B and 3C. However, these assemblies do not allow for maximum energy absorption and maximum distance travel. On the other hand, a flexible cup in lieu of the rigid cup, while providing increased energy absorption and distance travel, does not provide the system with a definite stop. Accordingly, the preferred embodiment of this invention provides a cup with the energy absorption and distance travel of the flexible cup along with the definite stop of the rigid cup.

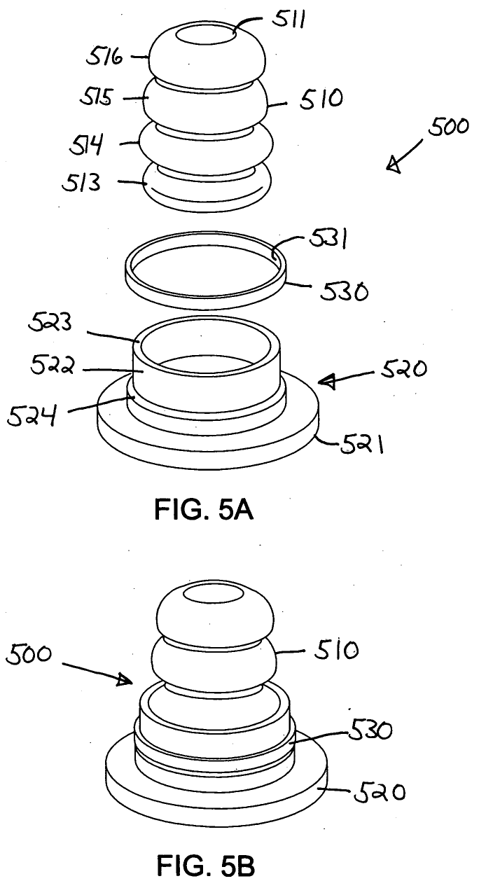

A parts view of the jounce bumper cup according to the invention is shown in FIG. 5A and an assembled view is shown in FIG. 5B. The same reference numerals will be used for the same parts in different views. The bumper 500 consists of a bumper 510, a flexible cup 520, and a ring 530. The bumper 510 may be made of any compressible material that can absorb energy and return to its original shape after such energy absorption. Preferably the bumper 510 is made of a microcellular urethane (MCU) and can be made from the process of molding, extrusion, and the like. The bumper may have hole 511 therethrough for a rod portion of a strut assembly (not shown) or the hole may be dispensed with when the bumper assembly is used other arrangements (shown in FIGS. 6A-6C). Bumpers, such as bumper 510, have a variety of shapes. In the figure, bumper 510 has four levels of bumps 512, 513, 514 and 515, however, it should be noted that the specific design for the bumper 510 will depend on the particular needs and design of the bumper assembly 500.

The flexible cup 520 holds the bumper 510 and is made of a flexible material that can expand and contract in response to forces. Preferably, the flexible cup 520 is made of a thermoplastic urethane (TPU). It has a cup shape comprising a base portion 521, a body portion 522 and a rim portion 523. The flexible cup 530 also has a shoulder portion 524 for positioning the ring 530 thereon. When used in a strut assembly (not shown), the flexible cup 520 has a hole (not shown) in the base portion 521 aligned with the hole 511 of the bumper 510, for passage of the rod (not shown).

The ring 530 is a rigid material which restricts the expansion of the flexible cup 520. It can be made of a variety of rigid materials, such as plastic, steel, aluminum, or other rigid metals or materials. For purposes herein, the ring 530 is made of a metal. The ring 530 slides over the body portion 522 of the flexible cup 520 and rests upon the shoulder portion 524. The ring 530 should have an inner diameter 531 of similar diameter as the outer diameter of the body portion 522 to assure a snug fit.

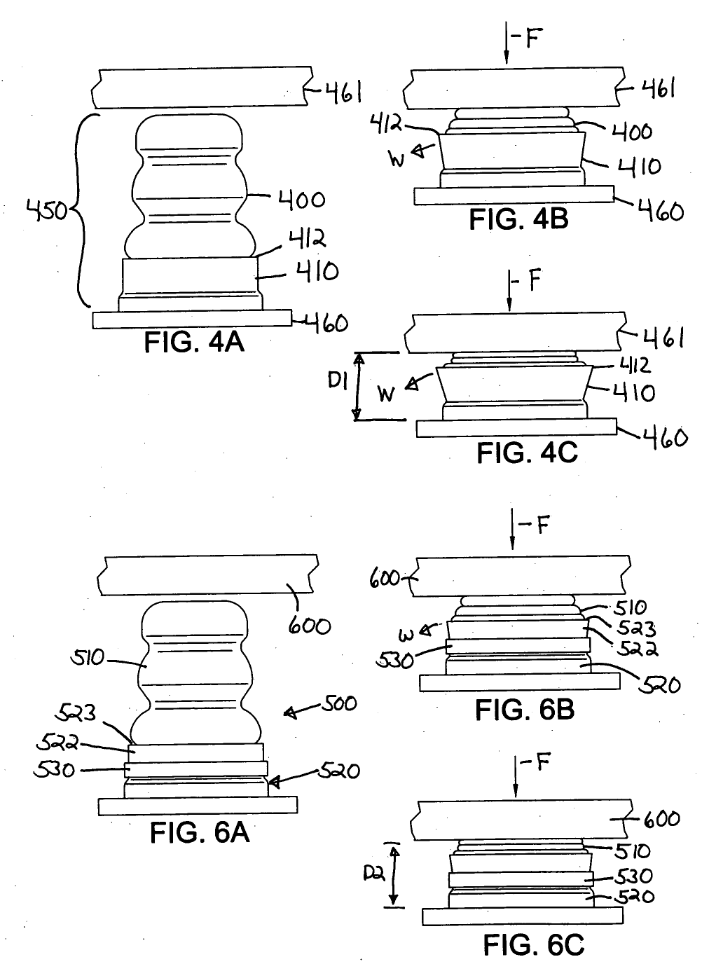

The sequence of operation of bumper assembly 500 is shown in FIGS. 6A, 6B and 6C. An object 600 is in alignment with bumper assembly 500. When object 600 applies a force upon bumper assembly 500 in the direction F, bumper 510 begins to compress and thus collapse into flexible cup 520. As the amount of force increases, bumper 510 further compresses and flexible cup 520 begins to expand outwardly at its rim portion 523 in the direction W. Thus, both bumper 510 and flexible cup 520 react to the force applied on bumper assembly 500. The ring 530, however, restricts the expansion of the flexible cup 520 because of its rigidity and only allows for an upper portion of the body portion 522 and rim portion 523 of the flexible cup 520 to expand. Compare the expansion of the flexible cup 410 in FIG. 4C and the flexible cup 520 in FIG. 6C. This reduction in expansion of flexible cup 520 means that bumper 510 does not compress radially as much as the bumper 400 shown in FIG. 6C. Therefore, the bumper 520 reaches maximum compression in a distance D2, larger than D1, and any increase of force F will be transferred through bumper assembly 500 to whatever assembly it is installed. The bumper assembly 500 with a small ring thus absorbs less energy and compresses at a larger distance than a no-ring bumper assembly. However, this bumper assembly 500 provides a definite stop to the compression force F.

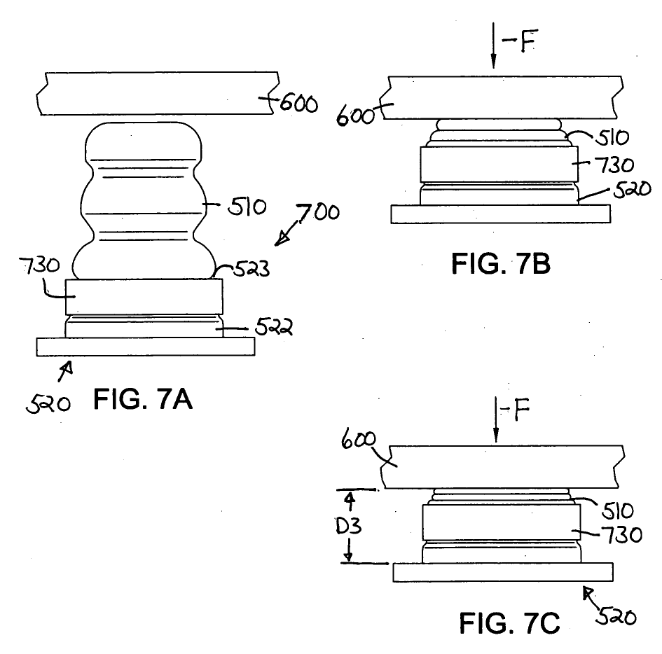

An alternative design of a bumper assembly with a ring is shown in FIGS. 7A, 7B and 7C, such bumper assembly 700 comprising a ring 730 having a larger width than ring 530. Note the height of ring 730 in comparison to the ring 530 in bumper assembly 500. The other components have similar structures and operations and thus they will not be described and will have the same reference numerals. A similar force through objects 600 will act in the direction F upon the bumper assembly 700. The bumper 510 similarly compresses into the flexible cup 520. The increased width of the ring 730 will restrict further the expansion of rim portion 523 and body portion (inside ring) of flexible cup 520 in comparison to ring 530. Such restriction has the effect of increasing the distance D3 of maximum compression of the bumper assembly, as shown in FIG. 7C.

As is illustrated above, the greater the width of the ring, the more the ring will restrict the expansion of the flexible cup and hence the bumper assembly will fully compress at larger distances. Thus, the universal bumper assembly is provided with various widths of rings to be mounted thereon. These rings at varying widths allow for tailoring the universal bumper assembly to have a rigid stop for a particular application. If more energy needs to be absorbed along with a greater distance requirement, a designer would choose a bumper assembly having a smaller ring and vice versa for less energy and less distance. Such can be chosen based on the application.

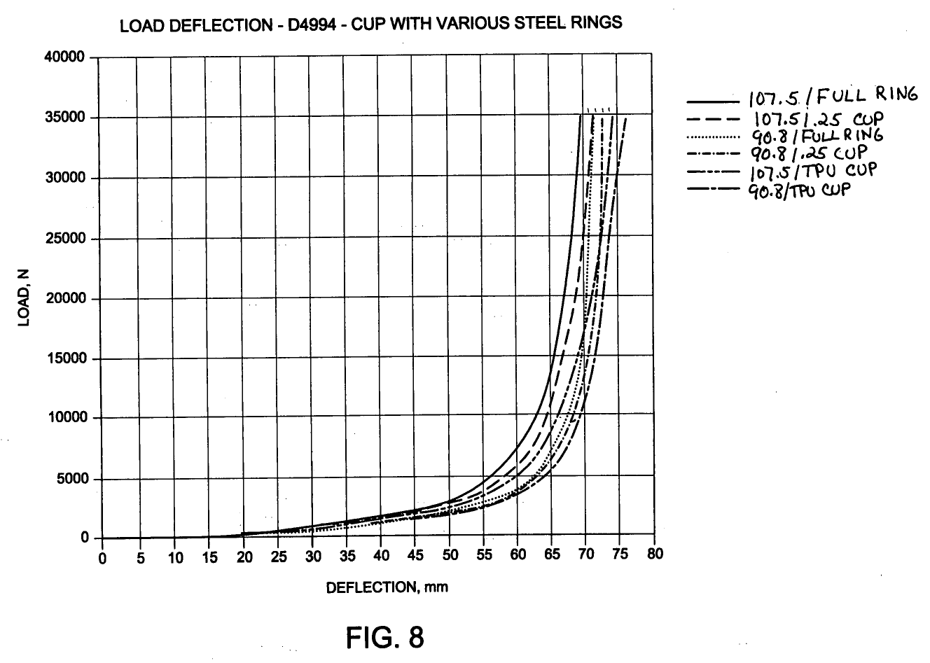

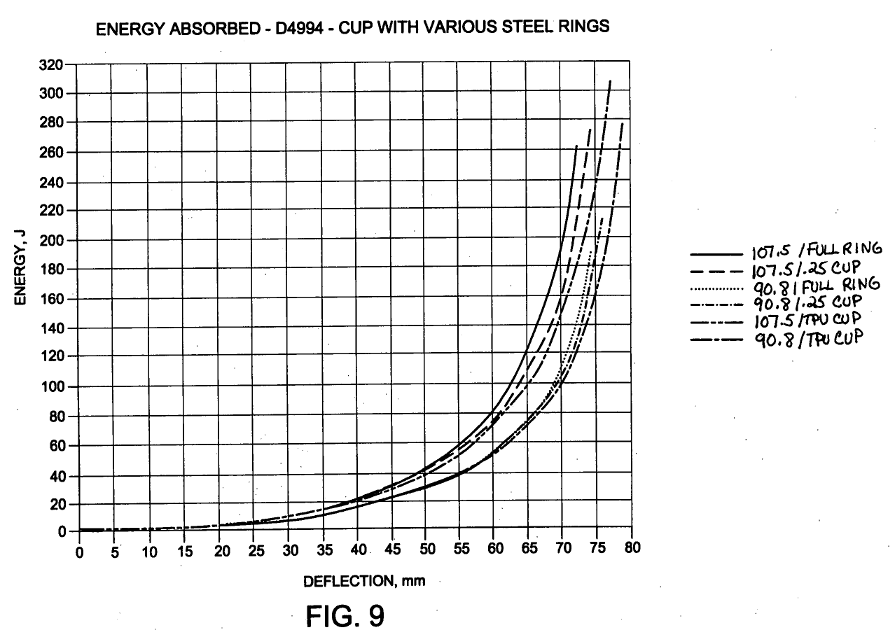

FIGS. 8 and 9 illustrate graphs demonstrating the utility of the present invention. Three bumper assemblies for two bumper types were compared. The first type used a 107.5 gram bumper in one assembly having no ring (107.5/TPU CUP), one with a ring extending one-fourth the height of the flexible cup (107.5/0.25 CUP) and one with a full ring extending the height of the flexible cup (107.5/FULL CUP). The second type used a 90.8 gram bumper in one assembly having no ring (90.8/TPU CUP), one with a ring extending one-fourth the height of the flexible cup (90.8/0.25 CUP) and one with a full ring extending the height of the flexible cup (90.8/FULL CUP). In each of the tests, the bumper assemblies were compressed at varying forces and energies. During the tests, the force exerted, the energy absorbed and the distance traveled all were recorded. The graphs in FIGS. 8 and 9 represent the results.

As noted in FIG. 8, the bumper assembly with the full ring (107.5/FULL RING) at approximately 35,000N was deflected to just under 70 mm, the quarter ring assembly (107.5/0.25 CUP) deflected about 72 mm and the bumper assembly with no ring (107.5/TPU CUP) deflected about 74.5 mm. In comparison to maximum energy absorbed with respect to deflection shown in FIG. 9, the bumper assembly with a full ring (107.5/FULL RING) deflected 72.5 mm at 263J, the quarter ring assembly (107.5/0.25 CUP) deflected about 74 mm at 275J and the bumper assembly with no ring (107.5/TPU CUP) deflected about 77.5 mm at 312J.

Similar results were found with the 90.8 gram bumpers. As noted in FIG. 8, the bumper assembly with the full ring (90.8/FULL RING) at approximately 35,000N was deflected about 71.5 mm, the quarter ring assembly (90.8/0.25 CUP) deflected about 73 mm and the bumper assembly with no ring (90.8/TPU CUP) deflected about 77 mm. In comparison to maximum energy absorbed with respect to deflection shown in FIG. 9, the bumper assembly with a full ring (90.8/FULL RING) deflected 74 mm at 190J, the quarter ring assembly (90.8/0.25 CUP) deflected about 76.5 mm at 212J and the bumper assembly with no ring (90.8/TPU CUP) deflected about 79 mm at 277J.

The graphs illustrate that the use of the ring influences the force the bumper assembly can withstand, the energy it can absorb and the distance it will travel while experiencing each of these influences. Note that a flexible cup with no ring will absorb the most shock and energy and provide more travel in comparison to the ringed cups. The addition of the rings reduce the force threshold, energy absorption and travel of the bumper assembly. Furthermore, as the height of the ring increases, the bumper assembly compression and travel decreases, as does the energy absorbed. Thus, when using a bumper in association with a flexible cup, one having ordinary skill in the art can vary the characteristics of the assembly with the addition of a rigid ring to restrict part or all of the expansion of the flexible cup. This can range from a negligible ring, such as a wire or other small ring to a full cylindrical tube surrounding all or nearly all of the flexible cup.

The foregoing describes an embodiment of a bumper assembly that is placed between a couple of components to absorb the shock and energy therebetween. However, it should be noted that other embodiments of the present invention, and obvious modifications to those skilled in the art are possible without departing from the scope of the present invention. For example, the bumper assembly could be used in a strut assembly wherein the rod or shaft of the strut passes through the center of the bumper assembly, which prevents the strut assembly from “bottoming out” or when the cylinder of the strut impacts a component of the vehicle. The bumper assembly would provide a cushion to prevent this impact. The bumper assembly could also be used in other situations where it is desired for two objects to not meet at a hard impact.

From the foregoing description, it is evident that there are other changes, modifications or alterations that can come within the province of a person having ordinary skill in the art. It is evident that any such changes, modification or alterations are specifically included in this description and this invention should only be limited by the claims following hereinafter.

1. A jounce bumper for a wheel suspension system of a vehicle including a first member and a second member displaceable relative to the first member along a line of travel, comprising:
a first flexible member disposed between said first and second member along the line of travel having a recess and an annular portion surrounding the recess therein aligned with the line of travel;
a second compressible member disposed between the first member and the first flexible member, having a portion thereof received within and seated in the recess; and
a ring member encircling the first flexible member,
wherein upon a force applied along the line of travel between, the second compressible member collapses into the recess causing the annular portion to expand radially.

2. The jounce bumper assembly according to claim 1 wherein the ring member restricts the expansion of the annular portion.

3. The jounce bumper assembly according to claim 1 wherein the recess of the first flexible member and the portion of the second compressible member are provided with complimentary, arcuate surfaces.

4. The jounce bumper assembly according to claim 3 wherein the second compressible member includes a longitudinal axis aligned with the line of travel and a radius of the recess of the first flexible member.

5. The jounce bumper assembly according to claim 1 wherein the second compressible member is microcellular urethane.

6. The jounce bumper assembly according to claim 1 wherein the first flexible member is thermoplastic urethane.

7. The jounce bumper assembly according to claim 1 wherein the jounce bumper assembly is mounted on the strut assembly of the vehicle.

8. The jounce bumper assembly according to claim 7 wherein the first member is one of a cylinder of the strut and a portion of the suspension and the second member is the other of the cylinder of the strut and the portion of the suspension.

9. The jounce bumper assembly according to claim 8 wherein the second compressible member has an aperture along said longitudinal axis through which a shaft of the strut member passes.

10. The jounce bumper assembly according to claim 1 wherein a central axis of the ring is coaxial with the line of travel.

11. The jounce bumper assembly according to claim 1 wherein a height of the first flexible member in the direction of the line of travel is greater than the height of the ring member.

12. The jounce bumper assembly according to claim 1 wherein a height of the first flexible member in the direction of the line of travel is equal to the height of the ring member.

13. The energy absorption device according to claim 1 wherein the ring is made of a non-flexible, non-compressible material.

14. The energy absorption device according to claim 13 wherein the ring is made of a metal.

15. The energy absorption device according to claim 13 wherein the ring is made of plastic.

16. An energy absorption device insertable between a first member and a second member displaceable with respect to each other along a line of travel, said device comprising:
a flexible member disposed between said first and second member along said line of travel having a recess portion and an annular portion surrounding said recess portion; and
a compressible member disposed along said line of travel and having a portion thereof received in said recess; and
a ring disposed around the first flexible member in abutting relation therewith,
wherein upon a force applied along said line of travel, said second compressible member collapses into said recess causing said annular portion to expand radially.

17. The energy absorption device according to claim 16 wherein said recess of said flexible member and said portion of said compressible member are provided with complimentary, arcuate surfaces.

18. The energy absorption device according to claim 16 wherein said flexible member is thermoplastic urethane and said compressible member is microcellular urethane.

19. The energy absorption device according to claim 16 wherein the compressible member is microcellular urethane.

20. The energy absorption device according to claim 16 wherein the flexible member is thermoplastic urethane.

21. The energy absorption device according to claim 16 wherein the ring restricts the expansion of the annular portion.

22. The jounce bumper assembly according to claim 16 wherein a central axis of the ring is coaxial with the line of travel.

23. The energy absorption device according to claim 16 wherein a height of the flexible member in the direction of the line of travel is greater than the height of the ring member.

24. The energy absorption device according to claim 16 wherein a height of the flexible member in the direction of the line of travel is equal to the height of the ring member.

25. The energy absorption device according to claim 16 wherein the ring is made of a non-flexible, non-compressible material.

26. The energy absorption device according to claim 25 wherein the ring is made of a metal.

27. The energy absorption device according to claim 26 wherein the ring is made of plastic.
